(19) United States
(12) Patent Application Publication
(10) Pub. No.: US 2017/0371237 A1
(43) Pub. Date: Dec. 28, 2017

(54) PROJECTION METHOD AND DEVICE FOR ROBOT

(71) Applicant: Qihan Technology Co., Ltd., Shenzhen (CN)

(72) Inventors: Lvde Lin, Shenzhen (CN); Yongjun Zhuang, Shenzhen (CN)

(21) Appl. No.: 15/239,876

(22) Filed: Aug. 18, 2016

(30) Foreign Application Priority Data
Jun. 28, 2016 (CN) 201610486532.X

(51) Int. Cl. G03B 21/32; G06T 7/60

(52) U.S. Cl. CPC G03B 21/32; G06T 7/60

(57) ABSTRACT

The present invention provides a projection method for a robot, the method comprises: receiving a playing command, according to a preset path, obtaining depth data of a projection area corresponding to the robot currently; according to a variation value of the depth data, determining whether the projection area is a flat surface; when the projection area is the flat surface, playing a film according to the playing command. The robot in the present invention can automatically search for the projection area that meets a projection requirement according to depth information of the projection area, such that operation procedures for a user can be greatly reduced, and an applicability of the user can be improved.

### FIELD OF THE INVENTION

The present invention relates to the technical field of robots, and more particularly to a projection method for a robot.

### BACKGROUND

With the development of the intelligent control technology, more and more intelligent robots have entered the people's living. For example, home service robots, such as a sweeping robot, a window cleaning robot, and so on, can help the people finish daily work automatically and high efficiently, and thus bring much convenience to the people's living. For example, a projection robot can play video files, such as a film, at home by projecting, such that a user can enjoy pleasure brought by a home theater at home, and it is helpful for the user to relieve the pressure on him/her and relax his/her mood.

In a work process of an existing projection robot, generally, a user selects an appropriate projection area, then aligns the projection robot with the projection area, and manually adjusts a screen size and a distance between the robot and the projection area, thereby ensuring a definition of broadcasting images. The entire operation process for broadcasting is relatively complicated, and fails to adapt to using requirements of ordinary consumers.

### BRIEF DESCRIPTION

A purpose of the present invention is providing a projection method for a robot, which aims at solving a problem in the prior art that a playing operation is relatively complicated and can't effectively adapt to a requirement of a common user.

In a first aspect, one embodiment of the present invention provides a projection method for a robot, the method comprises:

receiving a playing command, and obtaining depth data of a projection area corresponding to a robot currently according to a preset path;

according to a variation value of the depth data, determining whether the projection area is a flat surface; and

when the projection area is determined to be a flat surface, playing a film according to the playing command.

In combination with the first aspect, in a first possible implementation method of the first aspect, the step of obtaining depth data of a projection area corresponding to a robot currently according to a preset path comprises:

S1, moving the robot laterally from an initial position, obtaining the depth data of the projection area corresponding to the robot currently, and recording a number of times for which the robot has returned back to the initial position;

S2, when the robot has moved to a wall but still fails to find an appropriate projection area, turning the robot backwardly by 180 degrees and then moving the robot laterally to search for the appropriate area; and

S3, detecting the number of times for which the robot has returned back to the initial position in real time; if the number of times is 2, turning the robot by 90 degrees; if the number of times is 1 or 3, executing the aforesaid step S2; and if the number of times is 4, ending a search in the current room.

In combination with the first possible implementation method of the first aspect, in a second possible implementation method of the first aspect, the step of moving the robot in a lateral direction from an initial position, and obtaining the depth data of the projection area corresponding to the robot currently specifically comprises:

from the initial position, moving the robot laterally by a preset distance value in a predetermined direction for each time, and judging whether the projection area corresponding to the robot currently complies with a projection requirement or not.

In combination with the first aspect, in a third possible implementation method of the first aspect, the step of according to the variation value of the depth data, judging whether the projection area is a flat surface or not comprises:

according to a size of the projection area, dividing the projection area into a preset number of projection units;

according to the obtained depth data of the whole projection area, calculating average depth data corresponding to each of the projection units; and

comparing a difference value between the average depth data of any two adjacent projection units with a predetermined threshold value, and judging whether the difference value exceeds the threshold value;

if the difference value between the average depth data of any two adjacent projection units is less than the predetermined threshold value, determining that the projection area is the flat surface.

In combination with the first aspect, in a fourth possible implementation method of the first aspect, the step of when the projection area is determined to be the flat surface, playing a film according to the play command comprises:

when the projection area is determined to be the flat surface, according to size data of projection area included in the playing command, determining a distance between the robot and a projection screen; and

according to the distance between the robot and the projection screen, adjusting a projection focal length, selecting a film required by the playing command and playing the film.

In a second aspect, the embodiment of the present invention provides a projection device for a robot, the projection device for the robot comprises:

a depth data obtaining unit configured for receiving a playing command, and obtaining depth data of a projection area corresponding to a robot currently according to a preset path;

a flat surface judging unit configured for judging whether the projection area is a flat surface or not according to a variation value of the depth data; and

a playing unit configured for playing a film according to the playing command when the projection area is determined to be a flat surface.

In combination with the second aspect, in a first possible implementation method of the second aspect, the depth data obtaining unit comprises:

a moving sub-unit configured for moving the robot laterally from an initial position, obtaining the depth data of the projection area corresponding to the robot currently, and recording a number of times for which the robot has returned back to the initial position;

a turning sub-unit configured for turning the robot backwardly by 180 degrees when the robot has moved to a wall but still fails to find an appropriate projection area, and then moving the robot laterally to search for the appropriate area; and

a status detecting sub-unit configured for detecting the number of times for which the robot has returned back to the initial position in real time; if the number of times is 2, the robot is turned by 90 degree, if the number of times is equal to 1 or 3, a step S2 is executed; if the number of times is 4, a current search in a room is ended.

In combination with the first possible implementation method of the second aspect, in a second possible implementation method of the second aspect, the moving sub-unit is specifically configured for:

from the initial position, moving the robot laterally by a preset distance value according to a predetermined direction for each time, and judging whether the projection area corresponding to the robot currently complies with a projection requirement or not.

In combination with the second aspect, in a third possible implementation method of the second aspect, the flat surface judging unit 402 comprises:

a dividing sub-unit configured for dividing the projection area into a preset number of projection units according to a size of the projection area;

an average depth value calculating sub-unit configured for calculating average depth data corresponding to each of the projection units according to the obtained depth data of the whole projection area;

a depth comparing sub-unit configured for comparing a difference value of average depth data of any two adjacent projection units with a predetermined threshold value, and judging whether the difference value exceeds the threshold value; and

a flat surface determining sub-unit configured for determining that the projection area is the flat surface if the difference value of average depth data of any two adjacent projection units is less than the predetermined threshold value.

In combination with the second aspect, in a fourth possible implementation method of the second aspect, the playing unit comprises:

a distance determining sub-unit configured for determining a distance between the robot and a projection screen according to size data of projection area included in the playing command when the projection area is determined to be the flat surface; and

a focal length adjusting and playing sub-unit configured for adjusting a projection focal length according to the distance between the robot and the projection screen, selecting a film required by the playing command and playing the film.

In the present invention, when the robot receives the playing command, the robot searches a projection area according to a preset path, the position of the robot is automatically changed, and the depth data of the projection area corresponding to the robot is obtained after the position of the robot is changed. According to the variation value of the depth data, whether the projection area is a flat surface or not is judged; if the projection area is the flat surface, a video playing is performed according to the playing command. The robot in the present invention can automatically search for the projection area that meets a projection requirement according to depth information of the projection area, such that operation procedures of a user can be greatly reduced, and an applicability for the user can be improved.

### BRIEF DESCRIPTION OF THE DRAWINGS

FIG. 1 illustrates an implementation flow chart of a projection method for a robot provided by a first embodiment of the present invention;

FIG. 2 illustrates an implementation flow chart of a projection method for a robot provided by a second embodiment of the present invention;

FIG. 2a illustrates a schematic view of search paths of the robot provided by the second embodiment of the present invention;

FIG. 3 illustrates an implementation flow chart of a projection method for a robot provided by a third embodiment of the present invention;

FIG. 4 illustrates a structural schematic view of a projection device for a robot provided by a fourth embodiment of the present invention.

### DETAILED DESCRIPTION

In order to make the purposes, technical solutions, and advantages of the present invention be clearer and more understandable, the present invention will be further described in detail hereafter with reference to the accompanying drawings and embodiments. It should be understood that the embodiments described herein are only intended to illustrate but not to limit the present invention.

A purpose of the embodiments of the present invention is providing a projection method for a robot, which aims at solving a problem in the prior art that projection operations are relatively complicated when using a robot to perform a projection. When a projector-robot in the prior art gets to work, a user needs to select a position of the projector-robot according to an indoor scene and an area size required by projection, and a film is played according to the selected position. Since the aforesaid projection operations need to be accomplished by a professional technician, it is inconvenient for a common user to simply and conveniently control the projection robot to perform the projection operation, and thus the projector-robot in the prior art has a problem of a weak adaptability. The present invention will be specifically described hereinafter with reference to the accompanying drawings.

### Embodiment I

FIG. 1 illustrates an implementation flow of a projection method for a robot provided by a first embodiment of the present invention, which is described in detail as follows:

in a step S101, receiving a playing command, and obtaining depth data of a projection area corresponding to the robot currently according to a preset path.

Specifically, the received playing command described in the embodiment of the present invention can be a command that a user needs to play a certain film. For example, the user can control the robot to play a “film A” by a voice, thus, the robot automatically searches a projection area that meets a projection requirement according to a preset path, and automatically plays the “film A”.

Of course, the playing command can also comprise other control information, such as a position control information; taking “playing the film A in room X” as example, the robot automatically moves to the predetermined room X according to the position information included in the playing command, and searches for the projection area that meets the projection requirement in the room X.

In a preferred embodiment, the command can also comprise “size information of the projection area”, for example, a size of a commonly used projection area can be 80 inches, 100 inches, 120 inches or 150 inches, and their corresponding lengths and widths can be preset by the user or be adjusted according to a size of a film. For example, a projection area corresponding to the size of 80 inches can be set to have a length of 1.7 meters and a width of 1.0 meter.

With respect to the preset path, according to the requirements of different rooms, the path can be preset by the user. A unified path setting mode can also be adopted, so that when the robot searches the projection area according to the path, it can perform a search for most or all wall surfaces in the room.

With respect to the projection area corresponding to the robot currently, generally, an area where the robot faces is used as a projection area corresponding to the robot currently. With respect to the depth data of the projection area, a depth value of an object in an image can be determined by images collected by a depth sensor, such as a binocular camera.

In a step S102, according to a variation value of the depth data, determining whether the projection area is a flat surface.

Specifically, the variation value of the depth data in this embodiment of the present invention can be an amplitude of variation of the depth data of the entire projection area; for example, after the depth data of each pixel in the projection area is obtained, whether the variation value of the depth data is greater than a predetermined threshold value is determined; if the variation value is greater than the predetermined threshold value, it means that there exists a greater variation of depth data in the projection area, and there may be an irregular object in the projection area.

Since the robot is not exactly parallel to the wall body, a greater difference value may exist between a maximum value and a minimum value of the depth data of the entire projection area. Therefore, in order to improve an accuracy of determining whether two surfaces are the same flat surface by a comparison value of the depth data, when a comparison of the depth data is performed, the depth data of adjacent pixels, or average depth values of adjacent areas can be compared.

In a comparing process, once there exists any variation value that is greater than a preset depth variation threshold value, it means the current projection area doesn't lie in a same flat surface; when a projection is performed, the user may be affected and cannot normally and effectively watching projection pictures, and thus the projection area doesn't comply with a projection requirement. When the projection area doesn't comply with the projection requirement, a next position is searched and whether a projection area corresponding to the next position meets the projection requirement or not is further judged; when none of the positions meets the projection requirement, a search result prompt can be sent to the user to indicate the user that a current search for projection area in this room has been completed and no effective projection area is found.

In a step S103, when the projection area is determined to be a flat surface, playing a film according to the playing command.

If none of variation values in the projection area obtained in the search process exceeds the preset threshold value, it is determined that the current projection area meets the projection requirement and a watching requirement, and can be used for displaying films.

According to a playing requirement included in the playing command input by the user, for example, instruction information such as a selected film or a selected playing time, film playing is controlled. Of course, by a control command such as a voice control, a playing course such as a pause, a fast forward, and so on, can also be controlled at any time.

In addition, in order to improve the quality of playing effectively, when the projection area is determined to be the flat surface, according to the size data of the projection area included in the playing command, the distance between the robot and a projection screen is determined; according to the distance between the robot and the projection screen, a projection focal length is adjusted, and a film required by the playing command is selected and played.

For example, when the size data of the projection area included in a user command is 120 inches, a projection image with a corresponding dimensional proportion is generated according to the user command, and according to a requirement of the projection focal length, the robot is controlled to move to a robot position corresponding to the projection focal length.

In the present invention, when the robot receives the playing command, the robot automatically changes its position according to the preset path that is used to search for the projection area; and when the position of the robot is changed, the depth data of the projection area corresponding to the robot is obtained. According to the variation value of the depth data, whether the projection area is the flat surface or not is judged; if the projection area is the flat surface, a video playing is performed according to the playing command. The robot described in the present invention can automatically search for the projection area that meets the projection requirement according to depth information of projection areas, operating procedures of the user can be greatly reduced, and an adaptability for the user can be enhanced.

### Embodiment II

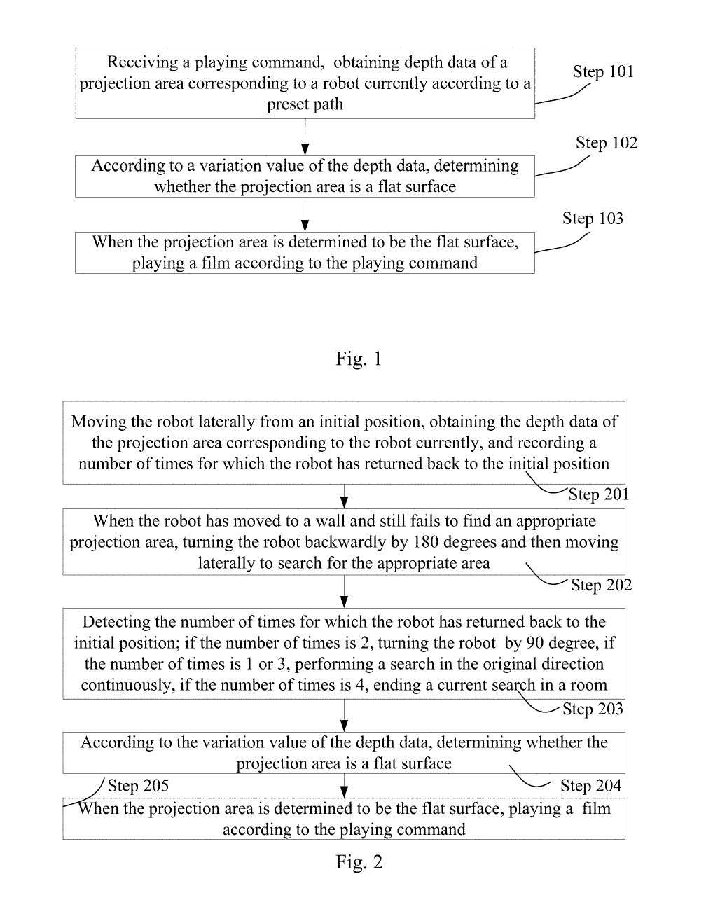

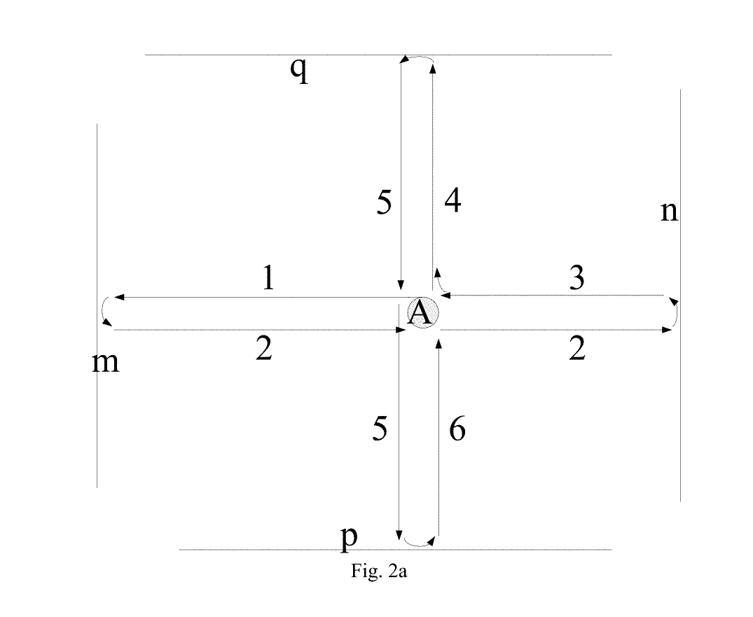

FIG. 2 illustrates an implementation flow of a projection method for a robot provided by a second embodiment of the present invention, which is described in detail as follows:

In a step S201, receiving a playing command, moving the robot laterally from an initial position, obtaining the depth data of the projection area corresponding to the robot currently, and recording a number of times for which the robot has returned back to the initial position.

Specifically, the initial position described in this embodiment of the present invention can be a position of the robot that has entered a room, or be a position of the robot that receives a user command.

The robot starts a lateral movement from the initial position, the robot can move in a left direction or a right direction. The moving mode can be a moving mode with a constant speed; in a process of moving at a constant speed, the robot obtains the depth data in real time, analyzes and processes the depth data, and judges whether the depth data obtained by the robot meets the projection requirement or not.

Said lateral movement is defined with respect to the projection area detected by the robot. By the lateral movement, the robot can keep in parallel with a wall surface appropriately, and the depth data between the robot and the wall surface can be conveniently detected.

The robot can also move intermittently, for example, the robot can move by 1 meter in a left or right direction for each time, after a movement of the robot, and analyze a projection area corresponding to the robot currently after the movement; if the projection area meets a projection requirement, a continued movement is unnecessary; if the projection area doesn't meet the projection requirement, the robot is further moved towards a next position.

In a moving process of the robot, if a projection area that meets the projection requirement is not found throughout, it is needed to find projection positions as many as possible in the room; in order to meet the requirement for searching for a plurality of positions, the present invention further comprises recording the number of times for which the robot has returned back to the initial position; moreover, in combination with a step S203, a high-efficient position search, which is as comprehensive as possible and does not need to be repeated, is realized in the room.

In a step S202, when the robot moves to a wall but still fails to find an appropriate projection area, turning the robot backwardly by 180 degrees and searching for the appropriate projection area in the lateral direction.

Specifically, when the robot in this embodiment of the present invention moves laterally, if a sensor detects that the robot has moved to a position adjacent to the wall surface, the robot is turned by 180 degrees so that the robot can detect another opposite wall surface. Moreover, a detecting method in this embodiment is the same as the previous detecting method, by the method of moving at a constant speed or intermittently, a projection area of the another wall surface can be detected.

In a step S203, detecting a number of times for which the robot has returned back to the initial position; when the number of times is 2, the robot is turned by 90 degrees; if the number of times is 1 or 3, executing the aforesaid step S202; if the number of times is 4, ending a current search in the room.

As shown in FIG. 2a, the initial position of the robot is marked as A, if the robot fails to find a projection area that meets the projection requirement, a movement path of the robot is shown in FIG. 2a, which comprises steps as follows:

1, the robot moves left to a wall surface m firstly, and in the moving process, whether a left side portion of a wall surface q meets the projection requirement or not is detected;

2, when the robot is adjacent to the wall m, it is turned by 180 degrees and moves towards a wall n, and continues to move towards the wall n when it returns back to the initial position for a first time; whether a wall surface p can meet the projection requirement or not is detected;

3, when the robot is adjacent to the wall surface n, it is turned by 180 degrees, and moves towards the wall surface m; and whether a left portion of a wall surface q meets the projection requirement or not is detected;

4, when the robot arrives at the initial position for a second time, it is turned left (in an actually operation, it can also be turned right) by 90 degrees, and moves in the wall surface q direction; whether an upper portion of the wall n meets the projection or not is detected;

5, when the robot is adjacent to the wall surface q, it is turned by 180 degrees and moves towards a wall surface p; when the robot arrives at the initial position for a third time, it continues to move towards the wall p, and whether the surface wall m meets the projection requirement or not is detected;

6, when the robot is adjacent to the wall p, it is turned by 180 degrees and moves towards the wall surface q, whether a lower portion of the wall surface n meets the projection requirement or not is detected. When the robot arrives at the initial portion for a fourth time, projection areas of the four wall surfaces in the room have been searched, and thus the search for the projection area is ended.

In any one of the aforesaid steps, if a projection area that meets the projection requirement is found, subsequent steps should be ended, and a film is projected and played.

In a step S204, according to a variation value of the depth data, determining whether the projection area is a flat surface.

In a step S205, when the projection area is determined to be a flat surface, playing the film according to the playing command.

The step S204 and S205 in this embodiment of the present invention are substantially the same as the step S102 and S103 in the first embodiment respectively, and are not repeatedly described here.

This embodiment of the present invention has specifically described an implementation mode of the preset path based on the embodiment I, a search method of the robot is controlled correspondingly by recording the number of times for which the robot has returned back to the initial position, such that the present invention can accomplish a high efficient search for projection areas of the wall surfaces in the room, repeated searches can be avoided, and an efficiency of searching for the projection areas can be effectively improved.

### Embodiment III

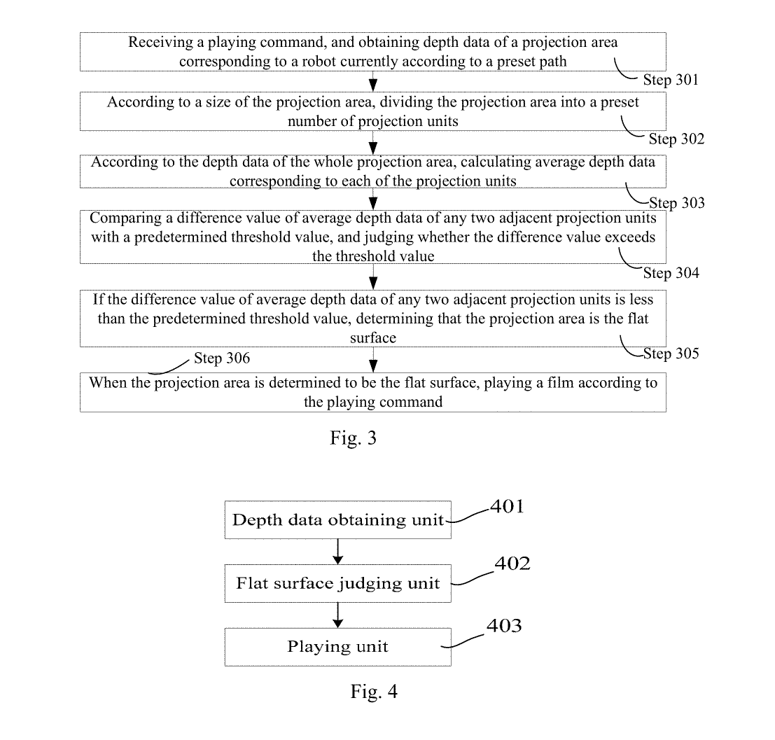

FIG. 3 illustrates an implementation flow of a projection method for a robot provided by a third embodiment of the present invention, which is described in detail as follows:

In a step S301, receiving a playing command, and, obtaining depth data of a projection area corresponding to the robot currently according to a preset path.

In a step S302, according to a size of the projection area, dividing the projection area into a preset number of projection units.

Specifically, the projection units described in this embodiment of the present invention can be modified correspondingly according to the size of the projection area. For example, as for a projection area having a size of 100 inches, a length of the projection area is 2.2 meters and a width of the projection area is 1.2 meters; the projection area can be divided into 220×120 projection units each having an area of 1 cm×1 cm, or be divided into 110×60 projection units each having an area of 2 cm×2 cm; a division of the projection area can be flexibly selected according to a requirement of a user or a calculation accuracy. The larger the number of the divided projection units, the larger the calculated amount, and the higher the accuracy of judgment.

In a step S303, according to the obtained depth data of the entire projection area, calculating average depth data corresponding to each of the projection unit.

As for each of the divided projection units, a divided projection unit can comprise a plurality of pixels, and depth data of each of the pixels can be obtained in advance. According to depth data of the pixels of the divided projection unit, average depth data of each of the divided projection units can be obtained.

In a step S304, comparing a difference value between average depth data of any two adjacent projection units with a predetermined threshold value and judging whether the difference value is greater than the threshold value or not.

With respect to the preset threshold value, threshold values of different grades can be selected according to a requirement for a flat surface accuracy of the projection area. When a method for dividing the projection units is changed, the threshold value can also be modified correspondingly.

In a step S305, if a difference value between any two adjacent projection units is less than the predetermined threshold value, determining that the projection area is a flat surface.

If a difference value between average depth data of any two adjacent projection units is greater than the predetermined threshold value, it means the projection area is not a flat surface, and searching and determination for a next projection area can be further performed. If a difference value between average depth data of any two adjacent projection units is less than the predetermined threshold value, the projection area is determined to be the flat surface.

In a step S306, when the projection area is determined to be the flat surface, playing a film according to the playing command.

Based on the embodiment I, in this embodiment of the present invention, the projection area is divided into a plurality of projection units, the difference value between average depth data of adjacent projection units is compared with the predetermined threshold value, and thus whether the projection area is a flat surface that meets the projection requirement or not can be judged. By a judging method of this embodiment of the present invention, a judgment accuracy for a flat surface can be effectively improved, and an error that may be caused by an artificial judgment can be avoided.

### Embodiment IV

FIG. 4 illustrates a structural schematic view of a projection device for a robot provided by a fourth embodiment of the present invention, which is described in detail as follows:

The projection device for the robot in the embodiment of the present invention comprises:

a depth data obtaining unit 401 configured for receiving a playing command, and obtaining depth data of a projection area corresponding to the robot currently according to a preset path;

a flat surface judging unit 402 configured for judging whether the projection area is a flat surface or not according to a variation value of the depth data; and

a playing unit 403 configured for playing a film according to the playing command when the projection area is determined to be the flat surface.

Preferably, the depth data obtaining unit comprises:

a moving sub-unit configured for moving the robot laterally from an initial position, obtaining the depth data of the projection area corresponding to the robot currently, and recording a number of times for which the robot has returned back to the initial position;

a turning sub-unit configured for turning the robot backwardly by 180 degrees when the robot has moved to a wall and still fails to find an appropriate projection area, and then moving laterally to search for an appropriate area; and

a status detecting sub-unit configured for detecting the number of times for which the robot has returned back to the initial position in real time; if the number of times is 2, the robot is turned by 90 degree, if the number of times is 1 or 3, a step S2 is executed; if the number of times is 4, a current search in a room is ended.

Preferably, the moving sub-unit is specifically configured for:

from the initial position, moving the robot laterally by a preset distance value according to a predetermined direction for each time, and judging whether the projection area corresponding to the robot currently after a movement complies with a projection requirement.

Preferably, the flat surface judging unit 402 comprises:

a dividing sub-unit configured for dividing the projection area into a preset number of projection units according to a size of the projection area;

an average depth value calculating sub-unit configured for calculating average depth data corresponding to each of the projection units according to the obtained depth data of the whole projection area;

a depth comparing sub-unit configured for comparing a difference value between average depth data of any two adjacent projection units with a predetermined threshold value, and judging whether the difference value is greater than the threshold value; and

a flat surface determining sub-unit configured for determining that the projection area is the flat surface if the difference value of average depth data of any two adjacent projection units is less than the predetermined threshold value.

Preferably, the playing unit comprises:

a distance determining sub-unit configured for determining a distance between the robot and a projection screen according to size data of projection area included in the playing command when the projection area is determined to be the flat surface; and

a focal length adjusting and playing sub-unit configured for adjusting a projection focal length according to the distance between the robot and the projection screen, and selecting a film required by the playing command and playing the film.

The projection device for the robot in the embodiment of the present invention corresponds to the projection method for the robot in the embodiments I-III, and is not repeatedly described here.

In some embodiments provided by the present invention, it should be understood that the disclosed systems, devices and methods can be realized by other ways. For example, the device embodiment described above is merely for schematic; for example, the dividing of the units is merely a division of logic function, in an actual implementation, there can be other dividing ways; for example, a plurality of units or components can be combined or integrated into another system, or some characteristics can be ignored or not executed. In another aspect, the displayed or discussed mutual coupling, direct coupling, or communication connection can be an indirect connection or a communication connection through some interfaces, devices or units, and can be in an electrically connected form, a mechanically connected form, or other forms.

The units being described as separated parts can be or not be physically separated, the components displayed as units can be or not be physical units, that is, the components can be located at one place, or be distributed onto a plurality of network elements. According to actual requirements, some or all of the units can be selected to implement the purposes of the technical solution of the present embodiment.

In addition, in each of the embodiments of the present invention, all of the functional units can be integrated into a single processing unit; each of the units can also exists physically and independently, and two or more than two of the units can also be integrated into a single unit. The aforesaid integrated units can either be realized in the form of hardware, or be realized in the form of software functional units.

If the integrated units are implemented in the form of software functional units and are sold or used as independent products, they can be stored in a computer readable storage medium. Based on this comprehension, the technical solutions of the present invention, or the part thereof that has made contribution to the prior art, or the entire or a part of the technical solutions, can be essentially embodied in the form of software products, the computer software products can be stored in a storage medium, which comprises some instructions and is configured for instructing a computer device (which can be a personal computer, a server, a network device, or the like) to perform the entire or a part of the method in each of the embodiments of the present invention. The aforesaid storage medium comprises various mediums which can store procedure codes, such as a USB flash disk, a movable hard disk, a ROM (Read-Only Memory), A RAM (Random Access Memory), a magnetic disk, a disk, or the like.

The aforementioned embodiments are only preferred embodiments of the present invention, and should not be regarded as being any limitation to the present invention. Any modification, equivalent replacement, improvement, and so on, which are made within the spirit and the principle of the present invention, should be included within the protection scope of the present invention.

1. A projection method for a robot, comprising:
receiving a playing command, and obtaining depth data of a projection area corresponding to a robot currently according to a preset path;
according to a variation value of the depth data, determining whether the projection area is a flat surface; and
when the projection area is determined to be the flat surface, playing a film according to the playing command.

2. The method according to claim 1, wherein the step of obtaining depth data of a projection area corresponding to a robot currently according to a preset path comprises:
S1, moving the robot laterally from an initial position, obtaining the depth data of the projection area corresponding to the robot currently, and recording a number of times for which the robot has returned back to the initial position;
S2, when the robot has moved to a wall but still fails to find an appropriate projection area, turning the robot backwardly by 180 degrees and then moving the robot laterally to search for the appropriate area; and
S3, detecting the number of times for which the robot has returned back to the initial position in real time; if the number of times is 2, turning the robot by 90 degree, if the number of times is 1 or 3, executing the step S2; and if the number of times is 4, ending a current search in a room.

3. The method according to claim 2, wherein the step of moving the robot laterally from an initial position, and obtaining the depth data of the projection area corresponding to the robot currently specifically comprises:
from the initial position, moving the robot laterally by a preset distance value in a predetermined direction for each time, and judging whether the projection area corresponding to the robot currently complies with a projection requirement or not.

4. The method according to claim 1, wherein the step of judging whether the projection area is a flat surface or not according to the variation value of the depth data comprises:
according to a size of the projection area, dividing the projection area into a preset number of projection units;
according to the obtained depth data of the whole projection area, calculating average depth data corresponding to each of the projection units; and
comparing a difference value between average depth data of any two adjacent projection units with a predetermined threshold value, and judging whether the difference value exceeds the threshold value;
if the difference value between average depth data of any two adjacent projection units is less than the predetermined threshold value, determining that the projection area is the flat surface.

5. The method according to claim 1, wherein the step of when the projection area is determined to be the flat surface, playing a film according to the play command comprises:
when the projection area is determined to be the flat surface, according to size data of projection area included in the playing command, determining a distance between the robot and a projection screen; and
according to the distance between the robot and the projection screen, adjusting a projection focal length, selecting a film required by the playing command and playing the film.

6. A projection device for a robot, comprising:
a depth data obtaining unit configured for receiving a playing command, and obtaining depth data of a projection area corresponding to a robot currently according to a preset path;
a flat surface judging unit configured for judging whether the projection area is a flat surface or not according to a variation value of the depth data; and
a playing unit configured for playing a film according to the playing command when the projection area is determined to be the flat surface.

7. The device according to claim 6, wherein the depth data obtaining unit comprises:
a moving sub-unit configured for moving the robot laterally from an initial position, obtaining the depth data of the projection area corresponding to the robot currently, and recording a number of times for which the robot has returned back to the initial position;
a turning sub-unit configured for turning the robot backwardly by 180 degrees when the robot has moved to a wall and still fails to find an appropriate projection area, and then moving the robot laterally to search for the appropriate area; and
a status detecting sub-unit configured for detecting the number of times for which the robot has returned back to the initial position in real time; if the number of times is 2, the robot is turned by 90 degree, if the number of times is 1 or 3, a step S2 is executed; if the number of times is 4, a current search in a room is ended.

8. The device according to claim 7, wherein the moving sub-unit is specifically configured for:
from the initial position, moving the robot laterally by a preset distance value in a predetermined direction for each time, and judging whether the projection area corresponding to the robot currently complies with a projection requirement or not.

9. The device according to claim 6, wherein the flat surface judging unit comprises:
a dividing sub-unit configured for dividing the projection area into a preset number of projection units according to a size of the projection area;
an average depth value calculating sub-unit configured for calculating average depth data corresponding to each of the projection units according to the obtained depth data of the whole projection area;
a depth comparing sub-unit configured for comparing a difference value between average depth data of any two adjacent projection units with a predetermined threshold value, and judging whether the difference value exceeds the threshold value; and
a flat surface determining sub-unit configured for determining that the projection area is the flat surface if the difference value between average depth data of any two adjacent projection units is less than the predetermined threshold value.

10. The device according to claim 6, wherein the playing unit comprises:
a distance determining sub-unit configured for determining a distance between the robot and a projection screen according to size data of projection area included in the playing command when the projection area is determined to be the flat surface; and
a focal length adjusting and playing sub-unit configured for adjusting a projection focal length according to the distance between the robot and the projection screen, selecting a film required by the playing command and playing the film.
